(19) United States
(12) Patent Application Publication
(10) Pub. No.: US 2021/0035222 A1
(43) Pub. Date: Feb. 4, 2021

(54) DELAYED REWARD SAVINGS SYSTEM

(71) Applicant: Katie Lynn Schumacher, Ankeny, IA (US)

(72) Inventor: Katie Lynn Schumacher, Ankeny, IA (US)

(21) Appl. No.: 17/073,482

(22) Filed: Oct. 19, 2020

Related U.S. Application Data
(63) Continuation of application No. 15/436,076, filed on Feb. 17, 2017.

(51) Int. Cl. G06Q 40/06

(52) U.S. Cl. CPC G06Q 40/06

(57) ABSTRACT

A delayed reward savings system wherein a required or selected amount above a normal amount for a financial instrument is paid by an individual and transferred and maintained in an individual's reward savings account. Funds in the individual's rewards savings account are released to the individual based upon the occurrence of a predetermined circumstance or criteria.

### CROSS REFERENCE TO RELATED APPLICATION

This application is a Continuation of U.S. Ser. No. 15/436,076 filed on Feb. 17, 2017, the content of this application is hereby incorporated by reference in its entirety.

### BACKGROUND OF THE INVENTION

This invention is directed to a savings system and more particularly a savings system associated with traditional financial instruments. Additionally, this savings system is designed to provide a future income stream to the individual while simultaneously stabilizing the financial instrument for the individual and financial institution in the event of an individual's financial hardship.

Saving for the future is difficult for many individuals. One reason for this is that most financial decisions involve relatively small amounts of money. Decisions that involve a small amount of money are usually made with less financial angst as compared to decisions that involve a large sum of money. For example, purchasing a $3.00 cup of coffee requires less deliberation than buying a $1,000.00 set of furniture.

With respect to small amounts of money, there are many natural deliberation points related to spending decisions, but very few natural deliberation points related to savings. Spending is generally required for basic needs such as food, a place to live, etc. However, the only natural point of savings for many individuals is their paychecks. Many savings tools are unable to successfully provide individuals with savings options for smaller amounts of money. For example, CDs generally require a minimum amount to open, a minimum contribution amount, and individuals have no natural deliberation points for deciding whether to put additional funds into CDs.

This savings system increases the number of deliberation points for savings and allows smaller amounts of money to be saved. Since the savings system is tied to a reoccurring transaction, an individual has more opportunities to save and can save smaller amounts.

Another obstacle to saving for the future is that it is often difficult to see the payoff from making a good financial decision because many savings mechanisms are fungible. If an individual decided not to purchase the cup of coffee for the next year and save $1095, this is just one of many financial decisions the individual is making and different decisions in other areas will likely result in a net savings or net loss that is significantly different from the $1095 financial gain from the decision not to purchase coffee. Even if the individual deposited $1095 in a CD rather than keeping it intermingled in a savings account, CDs and savings accounts are generally viewed as one and the same since an individual can easily withdraw a CD and since the funds for a CD would have to be withdrawn in a lump sum from the savings account.

This savings system provides a layer of separation between the savings system and an individual's current funds because an individual has to wait until the future to receive these funds and only receives these funds if the agreed upon conditions with the financial institution are met with respect to the financial instrument.

The other obstacle to saving for the future is that many individuals have a compelling need to have easy access to money especially since most individuals are risk averse. If an emergency situation comes up or an individual loses his or her job, money needs to be easy to access. Moreover, many individuals have debt and other monthly obligations they need to pay for before committing to putting money away for the future. Other financial tools, such as automatic investment deductions and 401 k accounts, which do better at overcoming the first two obstacles mentioned previously, are not well-positioned to provide access to money for payment of debt and monthly obligations if needed.

This savings system provides a safety net of backup funding in the event of financial hardship because the savings is tied to a debt or other obligation.

Since this savings system addresses these obstacles to saving, it is likely to be desired by individuals. A savings mechanism or system like this is also of value to a financial institution by attracting new customers, increasing funds on hand to invest through increased savings, and improving financial stability of loans and the like by providing a balance to draw upon should an individual run into financial hardship and have difficulty meeting their financial commitment. Individuals would also benefit from the improved financial stability of loans as it would increase the amount of financial opportunities that were available to the individual and help the individual avoid financial problems in the event of financial hardship.

Therefore, an objective of the present invention is to provide a delayed reward savings system that increases the number of natural deliberation points for savings decisions for smaller amounts of money that cause less financial angst.

Another objective of the present invention is to provide a delayed reward savings system that provides an external mechanism to help individuals separate future savings from existing funds so that an individual can guarantee income into the future.

A still further objective of the present invention is to provide a delayed reward savings system that provides delayed gratification while at the same time allowing these funds to be applied to the financial transaction in the event of financial hardship.

These and other objectives will be apparent to those skilled in the art based upon the following written description, drawings and claims.

### SUMMARY OF THE INVENTION

A delayed reward savings system where a financial instrument provided by a financial institution is tied to a reward savings account for an individual. Once approved for a financial instrument the individual is either required by the financial institution and/or elects to participate in the delayed reward savings system.

The delayed reward savings system includes an amount or percentage above a normal amount that is required and/or selected, circumstances or criteria as to how the amount over normal is redeemed which is required and/or selected, and whether interest is paid and the rate of interest on the amount over normal.

Once determined, a bill for the normal amount and the amount over normal is sent to the individual. The individual pays the bill by transferring funds from the individual's personal financial account to the financial institution where the normal amount is transferred to the financial institution's account and the amount over normal is transferred to the individual's reward savings account maintained by the financial institution. Funds from the individual's reward savings account are automatically released to the individual or the financial institution account based upon the predetermined occurrence or criteria being met.

### BRIEF DESCRIPTION OF THE DRAWINGS

FIG. 1 is a schematic view of a delayed reward savings system; and

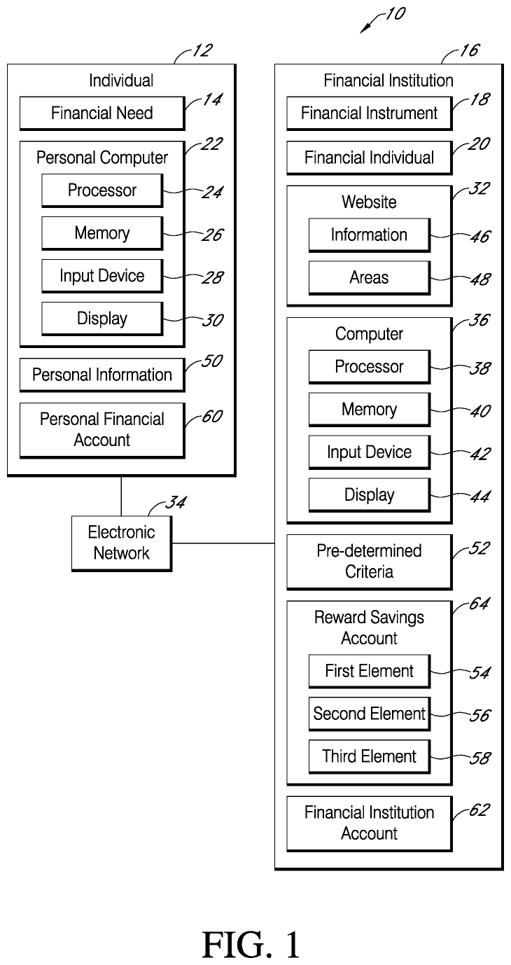

FIG. 2 is a flow diagram of delayed reward savings system.

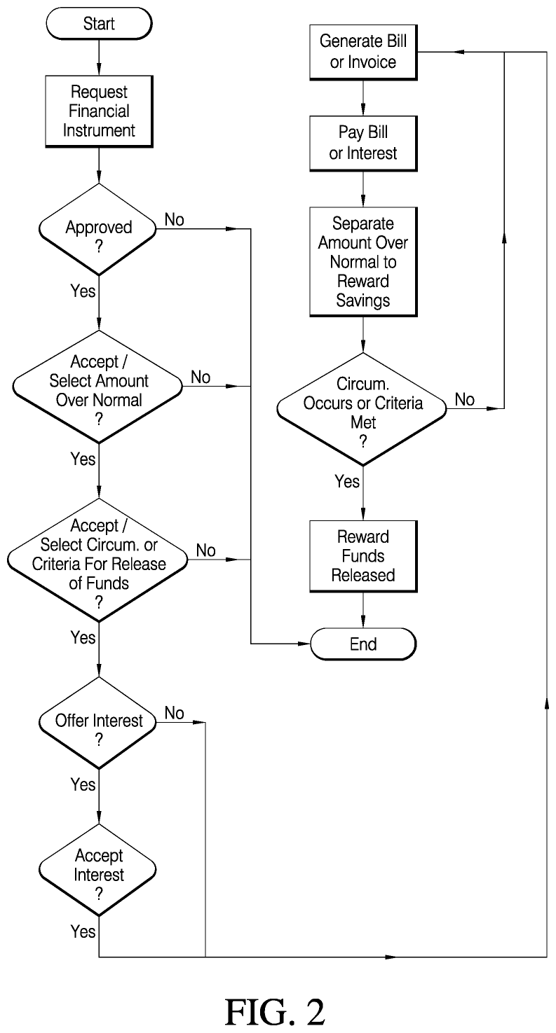

### DETAILED DESCRIPTION OF THE PREFERRED EMBODIMENT

Referring to the Figures, a delayed reward savings system 10 is used by an individual 12 having a financial need 14. The financial need is of any type and includes, but is not limited to purchase of a home, car, or consumer goods, tuition and expenses for school, insurance protection, or the like.

The individual 12 having the financial need 14 seeks out a financial institution 16 and requests a financial instrument 18 to assist with the financial need 14. The financial institution 16 is of any type and includes, but is not limited to, a bank, a credit union, a finance company, an insurance company, a merchant with a credit program, employers overseeing financial or insurance programs, or the like. The financial instrument 18 is of any type and includes, but is not limited to, a loan for a home, car, school or other merchandise, a credit and/or debit card account, an insurance policy, or the like.

The individual 12 seeks out and requests the financial instrument 18 by either physically meeting with a financial individual 20 or contacting the financial institution 16 electronically. To contact electronically, the individual 12, using a personal computer 22 having a processor 24, memory 26, input device 28, and display 30 accesses a financial institution's website 32 via an electronic network 34. The website 32 is connected to the financial institution's computer 36 having a processer 38, memory 40, input device 42, and display 44. The website 32 displays information 46 about the financial instrument 18 and provides areas 48 for the individual 12 to input personal information 50 that is stored in the memory 40 of the financial computer 36. The personal information 50 includes but is not limited to name, address, phone, e-mail, social security number, assets, liabilities income, expenses, and the like.

The financial individual 20 and/or the financial computer 36 reviews the personal information 50 and approves or disapproves the financial instrument 18 for the individual 12. The financial computer 36 using the processor 38 determines approval based upon comparing the personal information 50 with pre-determined criteria 52 that is input by the financial individual 20 and stored in the memory 40.

Once approved, the individual 12 is either required by the financial institution 16, or may elect to participate in, the delayed reward savings system 10. The delayed reward savings system 10 has at least three elements. A first element 54 is the amount or percentage of amount required or elected to be paid above the normal amount. The normal amount is the amount normally required by the financial instrument 18. For example, with a mortgage, the normal amount would include the principal, interest and escrow to be paid each month. With a credit card, the normal amount would be the required minimum for the month, the account balance at the end of the billing period, and/or the amount of each credit card transaction. For an insurance policy, the normal amount would be the monthly premium. For the amount above the normal amount, there can also be a minimum required amount and then the individual can elect to contribute above that required amount.

Information related to the first element 54 is communicated to the individual 12 preferably through a display on the website 32. If elected, the individual 12 makes selections as to how the normal amount is determined and what the amount or percentage above normal will be. These selections are stored in the memory 40 associated with the personal information 50.

The second element 56 involves the circumstances or criteria for release of the amount above normal. These circumstances/criteria are set by the financial institution 16 and/or selected by the individual 12. The circumstances/criteria include, but are not limited, to the status of the financial instrument 18 (i.e. is payment up to date), the expiration of a time period, obtainment of a milestone such as obtaining a specific savings amount, and/or payment in full of the financial instrument 18. Like the first element, requirements and/or selections for the second element 56 are communicated to the individual through the website 32 where the individual makes selections that are stored in the memory 40.

The third element 58 involves whether interest will be assessed to the amount/percentage paid over normal and the interest rate. Whether interest is provided is determined by the financial institution 16 and is communicated to the individual 12 preferably through website 32.

In operation, once the financial instrument 18 is approved, and the individual 12 accepts and/or selects the three elements 50, 52, and 54, the processor 38 calculates the normal amount and the amount/percentage over normal and produces a bill/invoice through the mail or over the electronic network 34 to the individual's computer 22. The individual pays the invoice either by cash, with a check, or by transferring funds from a personal financial account 60 to the financial institution 16. Receipt of funds from the individual are separated by the financial computer 36 using the processor and the normal amount is placed in the appropriate financial institution account 62 and the amount/percentage above normal is placed in the individual's reward savings account 64.

The funds in the rewards savings account 64 remain in the account until a circumstance or criteria of the second element 56 occurs. For example, if the individual 12 falls behind on payments, the processor 38 automatically transfers funds from the rewards savings account 64 to the appropriate financial institution account 62. If a time period has expired or a dollar amount has been reached in the savings account 64, the processor 38 drafts a check or transfers all or a percentage of the funds in the rewards savings account 64 to the individual's personal financial account 60.

If interest is to be paid, the processor 38 of the financial computer 36 automatically transfers funds from the financial institution's account 62 to the individual's reward savings account 64 based upon the determined interest rate.

Accordingly, a delayed rewards saving system has been disclosed that, at the very least, meets all the stated objectives.

What is claimed is:

1. A delayed reward savings system, comprising:
an individual's personal financial account;
a financial instrument provided by a financial institution related to a financial need of an individual;
an individual's reward savings account maintained by the financial institution; and
wherein an amount to be transferred from the individual's personal financial account is determined by a processor of a financial institution's computer that includes a normal amount for the financial instrument and an amount over the normal amount that is transferred and maintained in the individual's reward savings account.

2. The system of claim 1 wherein the amount over the normal amount is required by the financial institution.

3. The system of claim 1 wherein the amount over the normal amount is selected by the individual.

4. The system of claim 1 wherein the amount over the normal amount is maintained in the individual's reward savings account until a predetermined circumstance occurs.

5. The system of claim 1 wherein the processor of the financial institution's computer automatically transfers funds from the individual's reward savings account when payment on the financial instrument is not up to date.

6. The system of claim 1 wherein the processor of the financial institution's computer automatically transfers interest funds from a financial institution account to the individual's reward savings account based upon a predetermined interest rate.
